(19) United States
(12) Patent Application Publication
(10) Pub. No.: US 2018/0370554 A1
(43) Pub. Date: Dec. 27, 2018

(54) SHOPPING CART WITH CHECKOUT EQUIPMENT AND SYSTEM FOR USE

(71) Applicants: Huma Raza, Point Pleasant, NJ (US); Haidar KHAZAAL, Wilmington, DE (US)

(72) Inventors: Huma Raza, Point Pleasant, NJ (US); Haidar KHAZAAL, Wilmington, DE (US)

(21) Appl. No.: 16/020,351

(22) Filed: Jun. 27, 2018

Related U.S. Application Data
(60) Provisional application No. 62/525,233, filed on Jun. 27, 2017.

(51) Int. Cl. B62B 5/00; B62B 3/00; B62B 3/14; G06Q 20/20; G06K 7/14

(52) U.S. Cl. CPC B62B 5/0096; B62B 3/002; B62B 3/1492; G06K 7/1413; B62B 5/00; G06Q 20/202; G06Q 20/208; B62B 3/1404

(57) ABSTRACT

Described herein is a shopping cart with integrated checkout equipment. The cart contains at least one scanner positioned on an interior upper edge of a basket portion to enable the identification of items as they are placed into the basket. The cart portion is generally adapted for receipt into a docking station and includes at least one weight sensing means for determining the weight of an item placed into the basket portion.

### CROSS REFERENCE TO RELATED APPLICATIONS

This application claims priority to U.S. Provisional Patent Application No. 62/525,233 filed 27 Jun. 2017 to one of the above named inventors, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The disclosure of the present application relates generally to a shopping cart with integrated system features and equipment to aid in the checkout and purchasing process.

### BACKGROUND

Traditional shopping and checkout procedures, wherein a user places items into a cart while navigating store aisles and then proceeds to an appropriate cashier to complete the purchase of the items and bag them can generally be a tedious and a time consuming process.

To generally address these deficiencies, a number of recent solutions have been developed. One of these solutions is the use of a self-checkout, wherein a user generally speeds up the process of checking-out by scanning and paying for their items through a kiosk-like scanning and register device. These self-checkout solution generally fails to meet the needs of the market as items still need to be removed from the cart, scanned, placed into the bagging area, and paid for.

Still other solutions generally provide alternative solutions to shopping within a retail environment to generally streamline the selection and purchase of items. One such solution, is the process of ordering items online and scheduling a pickup or delivery. This solution generally fails to meet market needs as this solution may include added fees and costs and only provide a limited selection. Still further, this solution may not be desired by all customers as they generally enjoy shopping within a retail environment or browsing store shelves prior to making a purchasing decision.

Therefore, there is a need within the marketplace for solutions that generally aid in purchasing and paying for items within a retail environment. Preferably this solution is integrated into a shopping cart, includes features to calculate the weight of a given item, provides communicative features to update inventory in real-time and provide the location of a given item or category of goods, and allows for the dissemination of information related to a given item or promotion.

Additionally, it is preferred that the system and devices of the present disclosure are configured for docking within a station and adjacent devices for charging and updating. Preferably, this charging can be utilized in an outdoor environment wherein device charging can be accomplished through the collection of solar energy.

### SUMMARY OF THE INVENTION

The devices and systems of the present disclosure are generally configured to enable real-time checkout of items placed within a shopping cart to enable an efficient and expedient shopping experience within a retail environment. The devices of the present disclosure comprising a cart portion and a docking station configured to receive the cart portion when in a stored position.

The cart portion generally having a shape conforming to a traditional shopping cart providing a wheeled basket forming a cavity for the placement of items during shopping, wherein the cart portion is configured for nested receipt in an adjacent cart portion through receipt of a front portion of one cart portion in a rear portion of a second cart portion. Accordingly, the cart portion having a basket defining an interior space for the placement of items. The basket having an upper edge extending along a perimeter of the basket and generally defining the basket shape, and wherein all items placed within the basket pass by the upper edge. This upper edge including at least one scanner generally aligned towards the interior of the basket, wherein items placed within the basket are easily scanned upon entry into the basket. The basket further having a bottom including a weight sensing means, wherein an item placed within the basket can have its weight sensed and determined. The weight sensing means generally configured to indicate if an item placed within the cart has not been previously scanned, allowing a user to rescan the item or indicate the particular item type on a terminal, if the item does not have a bar code, such as produce.

The cart portion including a lower portion generally positioned under the basket and extending parallel to a length of the basket. The lower portion including the wheels and a second weight sensing means, wherein an item placed on the lower portion can have its weight sensed and determined. The second weight sensing means generally configured to indicate if an item placed of the lower portion of the cart has not been previously scanned, allowing a user to rescan the item or indicate the particular item type on the terminal, if the item does not have a bar code.

The cart portion further including a seat portion, the seat portion generally foldable and received on a hinged rear portion, wherein the seat portion is movable from a folded position to extended position. In the extended position the seat portion is positioned parallel to the length of the basket. The seat portion including a third weight sensing means, wherein an item placed on the seat portion can have its weight sensed and determined. The third weight sensing means generally configured to indicate if an item placed on the seat portion has not been previously scanned, allowing a user to rescan the item or indicate the particular item type on the terminal, if the item does not have a bar code, such as produce.

The cart portion including the terminal. The terminal generally including various systems and functioning as a computer and point of sale terminal allowing a user to pay for items placed within the cart. The terminal in communication with various devices of the cart including the first, the second, and the third weight sensing means. The terminal preferably positioned on a handle of the cart portion adjacent to the seat portion and generally functioning as communicative device for use within the retail environment for generally indicating the price of items purchased, displaying store maps, providing purchase and incentive information, and allow for updates to store inventories upon purchase. The terminal generally further functioning as a traditional retail point of sale terminal allowing a user to search for individual items, look up bar codes or item identifying codes, and utilize coupons and retail incentive or shopper accounts.

A second scanner device is generally placed on the handle and adjacent to the terminal, wherein the second scanner is preferably tethered to the cart and enables the scanning of items prior to placement into the cart.

The docking station configured to accept at least one wheel of the cart portion in an engagement for generally securing and providing an electronic coupling to the cart portion for charging and updating the various features of the device. Preferably the docking station includes a lower track portion generally shaped to receive the at least one wheel and having contacts to enable the electronic coupling. The docking station including a screen and payment area configured to provide information to and accept information for a user of the device and allow them to generally check-out the cart for use and enable its features for shopping. The docking station can be positioned within an interior space of a retailer or within an exterior space of a retailer, such as a parking lot. When in the exterior space, the docking station can be configured for charging itself and the various cart portions through a solar cell.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 shows a rear side view of the cart portion and docking station, according to the present disclosure;

FIG. 2 shows an isometric view of the cart portion and docking stations, according to the present disclosure;

FIG. 3 shows a rear side view of the docking station, according to the present disclosure;

FIG. 4 shows a side view of the docking station, according to the present disclosure;

FIG. 5 shows a side view of the cart portion, according to the present disclosure;

FIG. 6 shows an isometric view of the cart portion, according to the present disclosure;

FIG. 7 shows a top view of the cart portion, according to the present disclosure;

FIG. 8 shows an isometric view of the cart portion interior, according to the present disclosure;

FIG. 9A shows an isometric view of the rear of the cart portion, according to the present disclosure;

FIG. 9B shows and isometric view of the front of the cart portion, according to the present disclosure;

FIG. 10A shows an isometric view of an underside of the cart portion, according to the present disclosure;

FIG. 10b shows an isometric view of a wheel of the cart portion, according to the present disclosure;

FIG. 10C shows an isometric view of an upper of the cart portion, according to the present disclosure;

FIG. 11 shows an side view of the apparatus, according to the present disclosure; and

FIG. 12 shows an exploded view of the wheel engaged with the docking portion, according to the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure relates generally to a shopping cart configured to enable fast checkout through integrated equipment and adapted for receipt within a docking station for generally maintaining and charging the various equipment of the devices of the present disclosure.

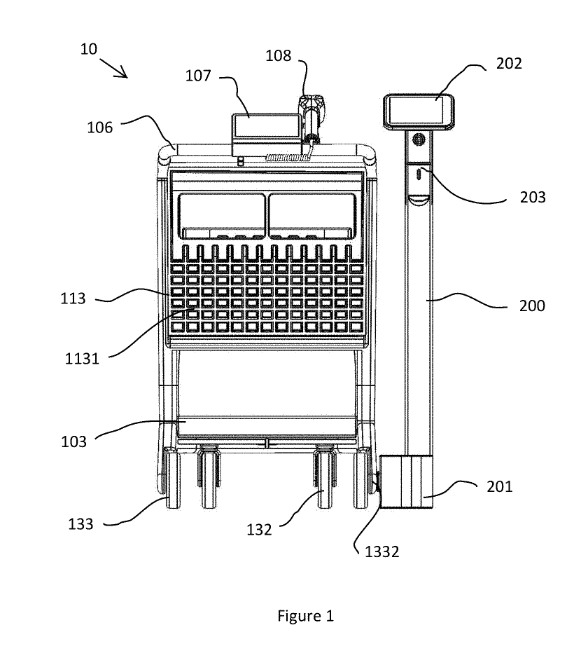

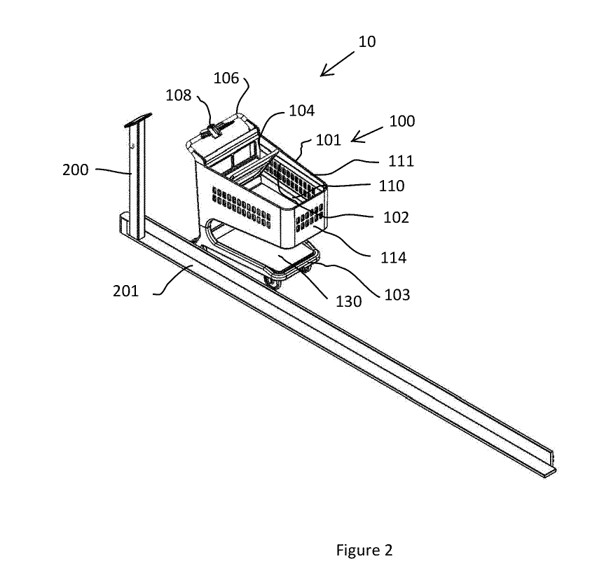

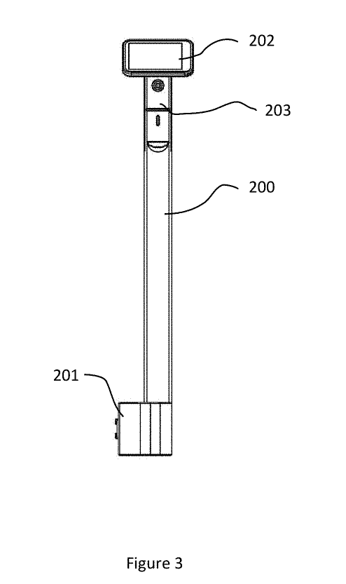

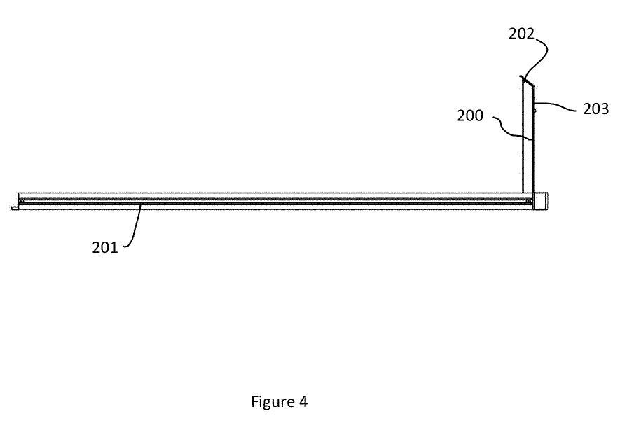

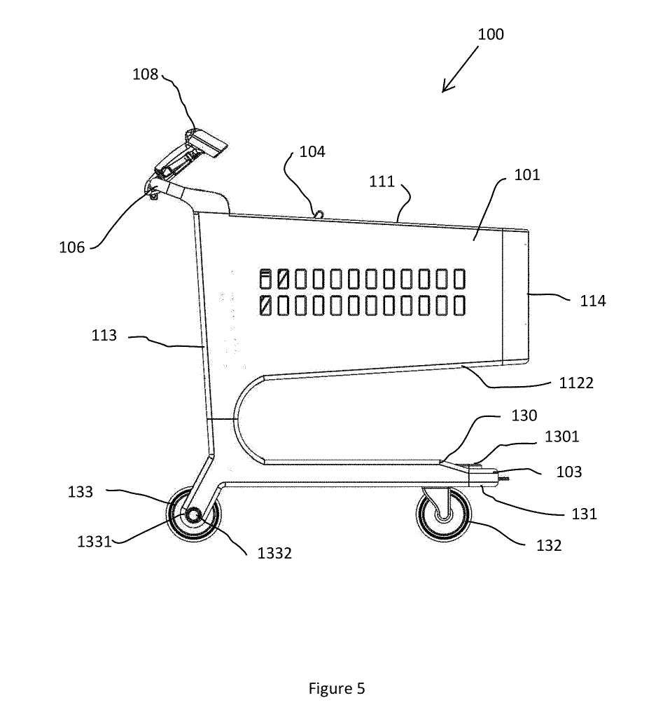

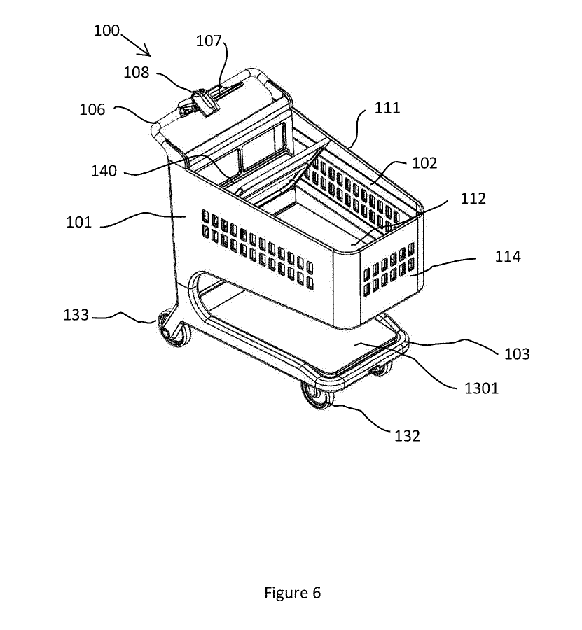

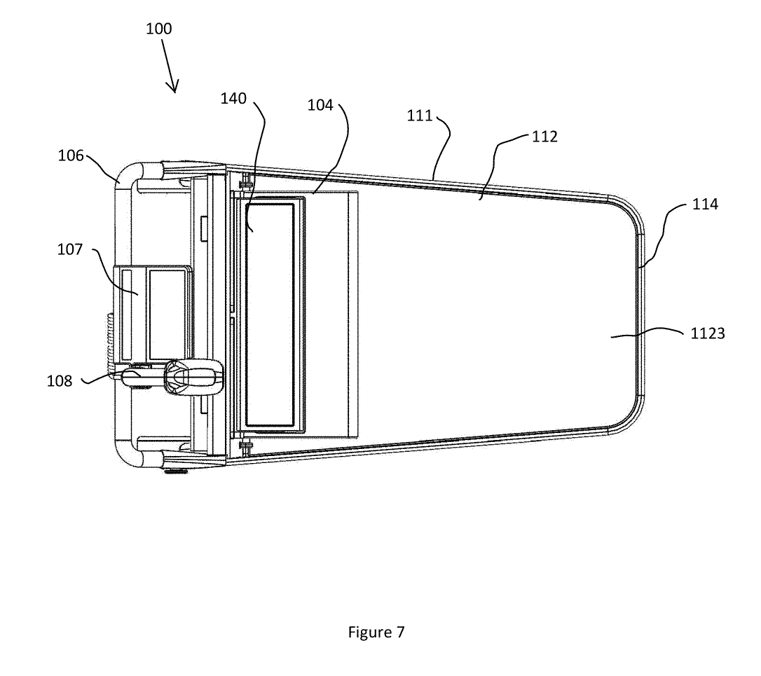

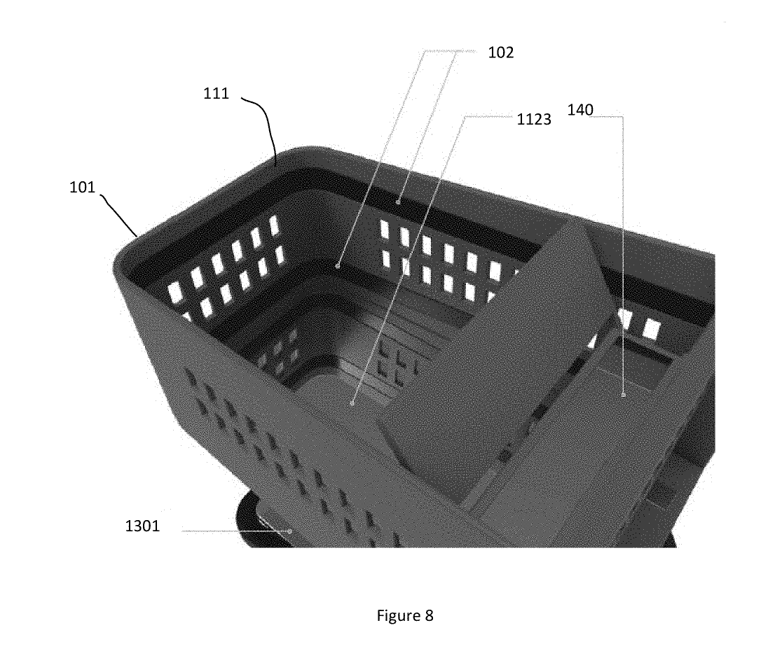

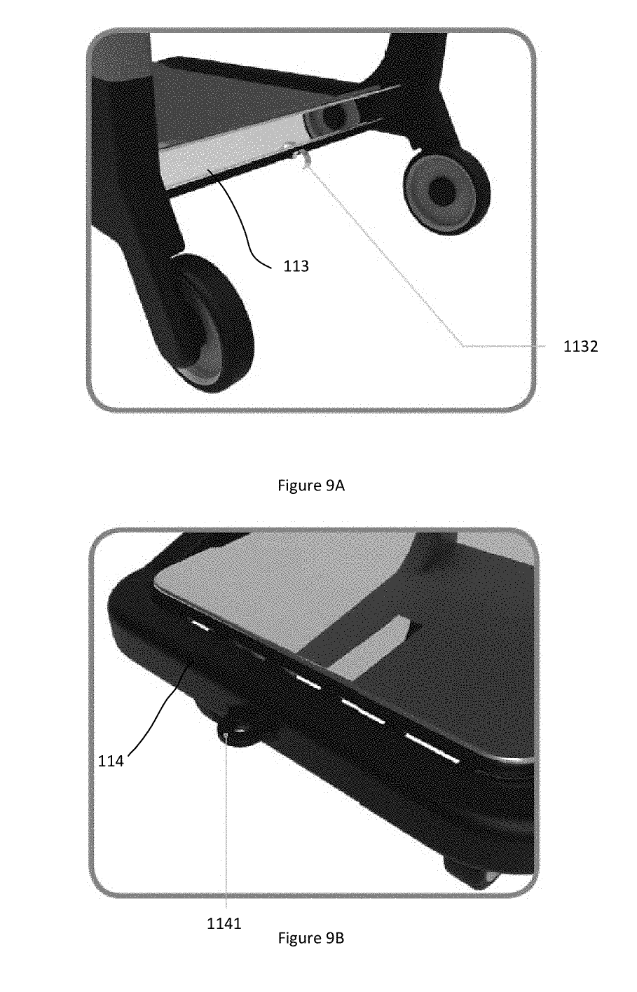

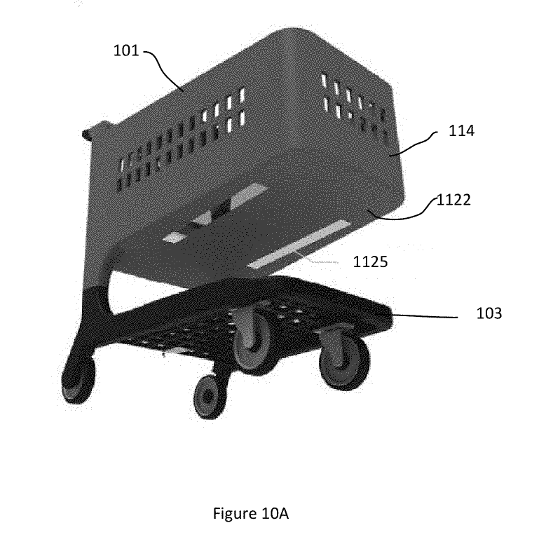

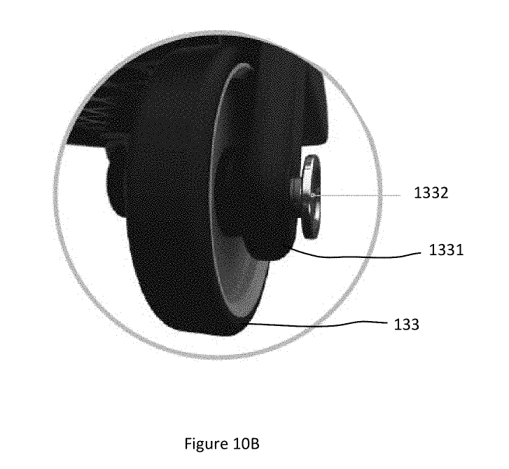

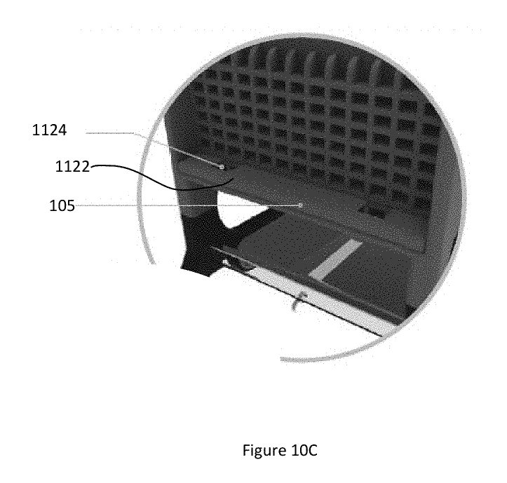

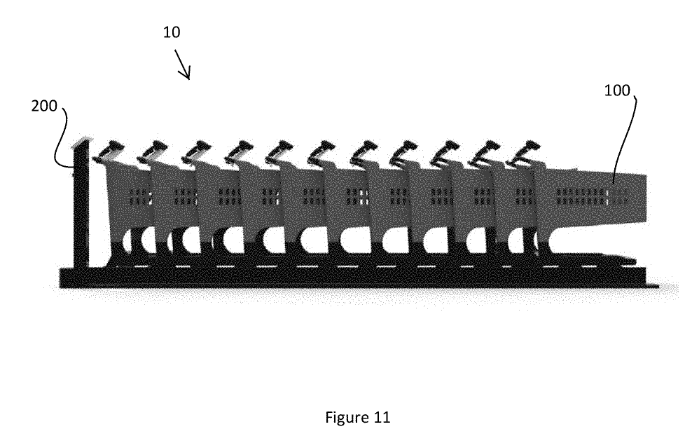

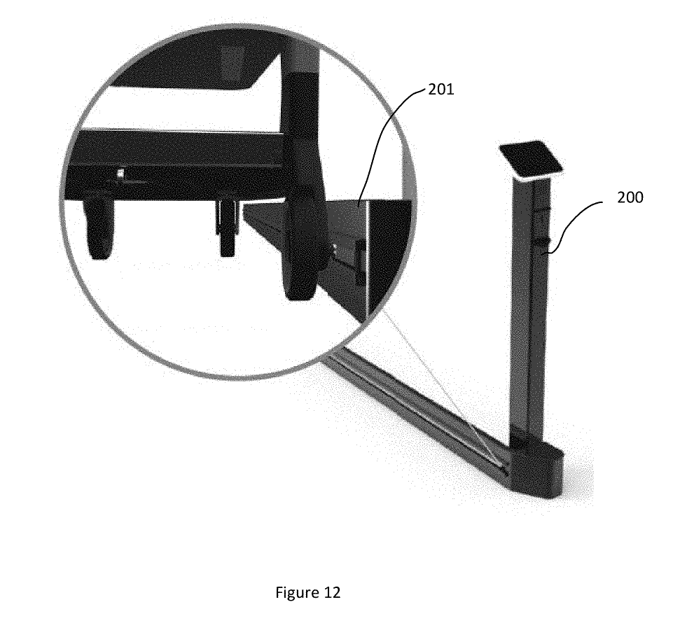

Referring to the figures, FIG. 1 to FIG. 12 show the shopping cart and docking station of the self-checkout device and system according to the present disclosure and generally referred to as device 10. The device 10 and systems of the device 10 enable real-time checkout of items placed within a shopping cart portion 100 to enable an efficient and expedient shopping experience within a retail environment. The cart portion 100 is configured for receipt in a docking station 200, wherein the cart portion 100 is placed into the docking station 200 in a stored position when not in use.

The cart portion 100 generally having a shape conforming to a traditional shopping cart providing a wheeled basket forming a cavity for the placement of items during shopping and wherein the cart portion 100 is configured for nested receipt in an adjacent cart portion 100 through receipt of a front portion 114 of one cart portion 100 in a rear portion 113 of a second cart portion 100. Accordingly, the cart portion 100 having a basket 101 defining an interior space 110 for the placement of items. The basket 101 having an upper edge 111 extending along a perimeter of the basket 101 and generally defining the basket 101 shape. As items are placed within the basket 101 interior 110 during shopping, the items will pass by the upper edge 111.

The upper edge 111 including at least one first scanner 102 generally aligned towards the interior space 110 of the basket 101, wherein items placed by a user and within the basket 101 are easily scanned upon entry into the basket 101. The at least one first scanner 102 encompassing the interior space 110 and configured to identify an item or items placed within the cart portion 100 interior space 110 for tracking and later purchase of the item. The at least one first scanner 102 may identify the item through a barcode on the item, wherein the at least one first scanner 102 is a barcode reader configured to optically read the barcode of the item. The at least one first scanner 102 may include, but not be limited to, a pen-type scanner, a laser scanner, a CCD or LED reader, a camera based reader, or other known barcode reading device. Alternately, the at least one first scanner 102 may use an alternate reading and item identifying technology, such as reading a radio frequency identification tag (RFID). Additionally, in alternate embodiments, the cart portion 100 may include a plurality of first scanners 102 positioned sequentially around the interior space 110 to generally increase the probability of scanning and identifying an item placed within the cart portion 100. Preferably, this at least one first scanner 102 is configured to quickly capture and identify an item as it is tossed or placed within the cart portion 100.

The basket 101 interior space 110 further having a bottom 112 opposite the upper edge 111 and having an upper surface 1121 forming a floor of the basket 101 and a lower surface 1122 on an opposed side of the upper surface 1121. The upper surface 1121 having a first weight sensing means 1123 configured to measure the weight of an item placed on the bottom 112, wherein an item placed within the basket 101 and on the upper surface 1121 of the bottom 112 can have its weight sensed and determined. The first weight sensing means 1123 may include a load cell configured to generate a signal corresponding to the weight of an item or may include a mechanical scale generally including a mechanism, such as a spring, to measure the weight of an item.

The first weight sensing means 1123 configured to identify an item placed within the interior space 110 that has not been previously scanned by the at least one first scanner 102 or a second scanner 108, allowing a user to rescan the item or indicate the particular item type on a terminal 107, if the item does not have a bar code, such as produce.

The cart portion 100 including a lower portion 103 positioned under the basket 101 below the bottom 112 and extending parallel to a length of the basket 101. The lower portion 103 having an upper portion 130 and an under portion 131. The under portion 131 including a first pair of wheels 132 and a second pair of wheels 133. The wheels 132, 133 contacting a ground surface and configured to allow for easy movement of the cart portion 100. The first pair of wheels 132 positioned at a front of the cart portion 100 lower portion 103 and configured as caster wheels to generally allow for rotation of 360 degrees about an axis parallel to the cart portion 100 length. The second pair of wheels 133 positioned at the rear 10 of the cart portion 100 opposed the first pair of wheels 132. The second pair of wheels 133 at a fixed position and having a hub 1331. At least one hub 1331 of the second pair of wheels 133 having a lug 1332. The lug 1332 extending beyond a width of the cart portion 100 and configured for receipt in a communicative coupling with the docking station 200.

The upper portion 130 of the lower portion 103 having a second weight sensing means 1301 configured to measure the weight of an item placed on the upper portion 130, wherein an item placed on the upper portion 130 can have its weight sensed and determined. The second weight sensing means 1301 generally mirroring the first weight sensing means 1123 and may include a load cell configured to generate a signal corresponding to the weight of an item or may include a mechanical scale generally including a mechanism, such as a spring, to measure the weight of an item placed on the upper portion 130. The second weight sensing means 1301 configured to identify an item placed on the upper portion 130 of the lower portion 103 that has not been previously scanned by the at least one first scanner 102 or the second scanner 108, allowing a user to rescan the item or indicate the particular item type on the terminal 107, if the item does not have a bar code or is too large for placement in the interior 110 of the cart portion 100.

The cart portion 100 further including a seat portion 104, the seat portion 104 generally foldable and received on a hinged flap 1131 of the rear portion 113, wherein the seat portion 104 is movable from a folded position to an extended position. In the extended position the seat portion 104 is positioned substantially parallel to the length of the basket 101. The seat portion 104 including a third weight sensing means 140 configured to selectively measure the weight of an item placed on the seat portion 104, wherein an item placed on the seat portion 104 can have its weight sensed and determined. The third weight sensing means 140 generally mirroring the first weight sensing means 1121 and the second weight sensing means 1301 and may include a load cell configured to generate a signal corresponding to the weight of an item or may include a mechanical scale generally including a mechanism, such as a spring, to measure the weight of an item placed on the seat portion 104. The third weight sensing means 140 configured to identify an item placed on the seat portion 104 that has not been previously scanned by the at least one first scanner 102 or the second scanner 108, allowing a user to rescan the item or indicate the particular item type on the terminal 107, if the item does not have a bar code, such as produce.

The upper surface 1121 of the bottom 112 of the basket 101 including at least one first charging strip 1124 positioned adjacent to the rear portion 113 and under the flap 1131. The at least one first charging strip 1124 coupled to a power source 105, preferably a rechargeable battery, wherein power from an electrical source is configured to travel from the at least one first charging strip 1124 to the power source 105 for charging the power source 105 for powering the features and systems of the cart 100.

The lower surface 1122 of the bottom 112 of the basket 101 including at least one second charging strip 1125. The at least one second charging strip 1125 coupled to and in a spatial alignment with the at least one first charging strip 1124 and coupled to the power source 105 wherein power from an electrical source is configured to travel from the at least one second charging strip 1125 to the first charging strip 1124 and the power source 105 for charging the power source to enable the power source 105 to enable and power the features and systems of the cart 100. Accordingly, the at least one first charging strip 1124 and the at least one second charging strip 1125 configured to be in contact when adjacent cart portions 100 are placed in a nested coupling. In this configuration the at least one second charging strip 1125 is received on top of the at least one first charging strip 1124. Preferably, the cart portion 100 bottom 112 includes a pair of charging strips 1124, 1125 to enable a robust coupling.

The cart portion 100 including a handle 106 generally integrated into a frame of the cart portion 100 and configured to allow a user to push and otherwise move the cart portion 100 during use. The handle 106 positioned adjacent to the rear portion 113 at an upper portion of the cart portion 100 and adjacent the seat portion 104. The handle 106 may include a generally hollow structure to allow for the placement of the various cables, cords, wire, and other similar materials to enable the communicative couplings of the various systems of the cart portion 100 and device 10.

The second scanner 108 is positioned on the handle 106 and provided in a tethered connection with the handle 106, wherein the user is able to use the second scanner 108 scan items prior to placement into the basket 101, on the lower portion 103, or on the seat portion 104. The second scanner 108 configured to identify an item or items for tracking and later purchase of the item. The second scanner 108 may identify the item through a barcode on the item, wherein the second scanner 108 is a barcode reader configured to optically read the barcode of the item. The second scanner 108 may include, but not be limited to, a pen-type scanner, a laser scanner, a CCD or LED reader, a camera based reader, or other known barcode reading device. Alternately, the second scanner 108 may use an alternate reading and item identifying technology, such as reading a radio frequency identification tag (RFID).

The device 10 including the terminal 107 positioned on the handle 106 and configured for viewing and use by a user. The terminal 107 including various systems and functioning as a computer and point of sale terminal allowing a user to pay for items placed within the cart portion 100. The terminal 107 in communication with the systems and devices of the cart including, but not limited to, the first weight sensing means 1123, the second weight sensing means 1301, the third weight sensing means 140, the at least one first scanner 102, and the second scanner 108.

The terminal 107 including a screen for generally viewing and selecting items or features and including hardware to allow for wireless communication with other systems within the retail environment, including, but not limited to, inventory systems and databases, item information, retail maps and locations, promotional information, coupon information, and customer information. Accordingly, the terminal 107 functions as communicative device for use within the retail environment for generally indicating the price of items purchased, displaying store maps, providing purchase and incentive information, and allows for updates to store inventories upon purchase or selection into the cart portion 100.

The terminal 107 generally further functioning as a traditional retail point of sale terminal allowing a user to search for individual items, look up bar codes or item identifying codes, and utilize coupons and retail incentive or shopper accounts. The terminal 107 further enabling coupling with an additional personal electronic devices, such as a cellular phone, utilizing an application for synching with the terminal 107 and configured to allow for enhanced features such as integrated with the application for the display of items to be purchased, such as a shopping list.

The docking station 200 configured to accept at least one wheel 132, 133 of the cart portion 100 in an engagement for generally securing and providing an electronic coupling to the cart portion 100 for charging and updating the various features of the device 10. In the preferred embodiment of the present disclosure, the docking station 200 includes a lower track portion 201 configured to receive the lug 1332 on the second wheels 133 in a secure coupling. The lower track portion 201 and lug 1332 configured with contacts to enable the electronic coupling, wherein the coupling is configured to update and charge the various features and systems of the cart portion 100. The docking station 200 including a screen 202 and payment area 203 configured to provide information to a user of the device 10 and allow them to use the cart portion 100 and its features for shopping. The docking station 200 generally requiring payment or the receipt of identifying information for a user, such as a frequent shopper number or card, to allow them to generally check-out the cart portion 100 for use and enable its features for shopping. The docking station 200 can be positioned within an interior space of a retailer or within an exterior space of a retailer, such as a parking lot. When in the exterior space, the docking station 200 can be configured for charging itself and the various cart portions through a solar cell, such as a photovoltaic cell.

In an alternate configuration for generally moving multiple cart portions 100, the cart portion 100 front portion 114 may include a loop 1141 configured to receive a hook member 1132 positioned on the rear portion 113 of the cart portion 100 for generally enabling the attachment of adjoining carts 100.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. An apparatus for use in a retail environment configured to enable self-checkout, the apparatus comprising:
a cart portion, the cart portion including:
a basket portion defining an interior for the placement of items during shopping, the basket portion including an upper edge extending around a perimeter of the basket portion, the upper edge including a scanner, the scanner configured to identify an item placed into the cart portion, the basket having a bottom, the bottom including a weight sensing means, wherein an item placed into the basket can have its weight determined;
a terminal, the terminal having electronic components and configured as a point of sale terminal in coupled communication with systems of the cart portion and configured to enable the purchase and identification of items placed into the cart portion;
a first pair of wheels; and
a second pair of wheels, the second pair of wheels including a lug, the lug configured for a communicative and electronic coupling with a docking station; and
the docking station, the docking station including a lower track portion, the lower track portion configured to receive the lug in an electronic coupling, wherein the coupling of the lug and the track portion secures the cart portion and charges the systems of the cart portion.

2. An apparatus as in claim 1, wherein the cart portion includes a lower portion, the lower portion positioned under the basket portion, the lower portion including an upper portion, the upper portion including a second weight sensing means, wherein an item placed onto the upper portion can have its weight determined.

3. An apparatus as in claim 2, wherein the cart portion includes a seat portion, the seat portion foldable and hingedly received on a rear portion of the cart portion, the seat portion including a third weight sensing means, wherein an item placed onto the seat portion can have its weight determined.

4. An apparatus as in claim 1, wherein the cart portion includes a second scanner, the second scanner tethered to the cart portion and configured to allow a user to scan an item for identification prior to placement into the basket.

5. An apparatus as in claim 1, wherein the basket portion includes an upper surface on the bottom and a lower surface on the bottom opposite the upper surface, the upper surface including a first charging strip coupled to a power source, the lower surface including a second charging strip in alignment with the first charging strip and coupled to the power source and the first charging strip, wherein power from an electrical source is configured to travel between the first charging strip and the second charging strip for charging the power source.

6. An apparatus as in claim 5, wherein the first charging strip of a first cart portion and the second charging strip of a second cart portion are configured for nested contact to charge the power source of each cart of the first cart and the second cart.

7. An apparatus as in claim 1, wherein the weight sensing means is a load cell.

8. An apparatus as in claim 2, wherein the second weight sensing means is a load cell.

9. An apparatus as in claim 3, wherein the third weight sensing means is a load cell.

10. An apparatus as in claim 1, wherein the scanner is configured to read a bar code placed on an item.

11. An apparatus as in claim 4, wherein the second scanner is configured to read a bar code placed on an item.

12. An apparatus as in claim 1, wherein the docking station includes a screen device and a payment area configured to enable a user to release the cart portion from the docking station for use.

13. A device configured to enable self-checkout during shopping within a retail environment, the device comprising:
a cart portion, the cart portion including:
a basket portion defining an interior space for the placement of items during shopping, the basket portion including:
an upper edge extending around a perimeter of the basket portion, the upper edge including at least one first scanner, the at least one first scanner configured to identify an item placed into the cart portion; and
a bottom, the bottom including a weight sensing means, wherein an item placed into the basket can have its weight determined, the bottom;
a lower portion, the lower portion positioned under the basket portion, the lower portion including an upper portion, the upper portion including a second weight sensing means, wherein an item placed onto the upper portion can have its weight determined;
a seat portion, the seat portion foldable and hingedly received on a rear portion of the cart portion, the seat portion including a third weight sensing means, wherein an item placed onto the seat portion can have its weight determined;
a terminal, the terminal having electronic components and configured as a point of sale terminal in coupled communication with the at least one first scanner, the first weight sensing means, the second weight sensing means, and the third weight sensing means configured to enable the purchase, measurement, and identification of items placed into the cart portion;
a power source, the power source rechargeable and coupled to the systems of the device;
a first pair of wheels; and
a second pair of wheels, the second pair of wheels including a lug, the lug configured for a communicative and electronic coupling with a docking station; and
the docking station, the docking station including a lower track portion, the lower track portion configured to receive the lug in an electronic coupling, wherein the coupling of the lug and the track portion secures the cart portion and charges the systems of the cart portion.

14. A device as in claim 13, wherein the cart portion includes a second scanner, the second scanner tethered to the cart portion and configured to allow a user to scan an item for identification prior to placement into the basket portion.

15. A device as in claim 13, wherein the basket portion includes an upper surface on the bottom and a lower surface on the bottom opposite the upper surface, the upper surface including a first charging strip coupled to the power source, the lower surface including a second charging strip in alignment with the first charging strip and coupled to the power source and the first charging strip, wherein power from an electrical source is configured to travel between the first charging strip and the second charging strip for charging the power source.

16. A device as in claim 15, wherein the first charging strip of a first cart portion and the second charging strip of a second cart portion are configured for nested contact to charge the power source of each cart of the first cart and the second cart.

17. A device as in claim 13, wherein the first weight sensing means, second weight sensing means, and third weight sensing means is a load cell.

18. A device as in claim 13, wherein the scanner is configured to read a bar code placed on an item.

19. A device as in claim 14, wherein the second scanner is configured to read a bar code placed on an item.

20. A device as in claim 13, wherein the docking station includes a screen device and a payment area configured to enable a user to release the cart portion from the docking station for use.
